(19) United States
(12) Patent Application Publication
(10) Pub. No.: US 2013/0132591 A1
(43) Pub. Date: May 23, 2013

(54) Method for the Operating of a Field Device

(71) Applicant: Endress + Hauser Wetzer GmbH + Co. KG, Nesselwang (DE)

(72) Inventors: Stephan Damith, Nesselwang (DE); Ulrich Syber, Schwangau (DE); Robert Wotsch, Nesselwang (DE); Christian Schneid, Nesselwang (DE); Bernd Briechle, Durach (DE)

(73) Assignee: Endress + Hauser Wetzer GmbH + Co. KG, Nesselwang (DE)

(21) Appl. No.: 13/677,448

(22) Filed: Nov. 15, 2012

(30) Foreign Application Priority Data
Nov. 18, 2011 (DE) 10 2011 086 630.2

(51) Int. Cl. H04L 29/06

(52) U.S. Cl. CPC H04L 65/1069
USPC 709/227

(57) ABSTRACT

A method for the operating of a field device of process automation technology, wherein data is exchanged via a connection between the field device and an operating device, for operating the field device, wherein the connection is established via a communication interface on the field device and a communication interface on the operating device, and wherein the communication interface of the operating device is a hardware communication interface, which is emulated by software, as an Ethernet interface.

The invention relates to a method for the operating of a field device.

Furthermore, the invention relates to an assembly, for the execution of the method, and a computer program product.

In process technology as well as automation technology, a wide variety of field devices are employed, which serve for the recording and/or manipulation of process variables. Measuring devices serve for the recording of process variables, such as, for example level measuring devices, flow measuring devices, pressure and temperature measuring devices, pH measuring devices, conductivity measuring devices, etc., which record the respective process variables level, flow, pressure, temperature, pH and conductivity, respectively. Employed in the manipulation of process variables are actuators, such as valves or pumps, via which, for example, the flow of a liquid in a pipe or the level of a medium in a container can be changed. In principle, all devices, which are employed in association with the process and which transfer, or process, process relevant information, are characterized as field devices. A wide variety of such devices are proffered by the Endress+Hauser group of companies. Thus, the term field device, when used in connection with the invention, comprises all types of measurement devices and actuators. The term field device furthermore comprises, for example, a gateway, a wireless adaptor or other bus devices that are integrated/integrable in a bus system.

In modern industrial facilities, field devices are usually connected to at least one superordinate control unit via bus systems, such as for example, Profibus® PA, Foundation Fieldbus® or HART®. Normally, superordinate control units may be, as previously mentioned, a control system or a [already, above more fully specified] control unit. The superordinate control unit serves for process control, process visualization and process monitoring as well as for the deployment and operating of the field devices. Programs, which run independently on the superordinate units, are for example, the operating application FieldCare from Endress+Hauser, the operating application Pactware, the operating application AMS from Fisher-Rosemount or the operating application PDM from Siemens. Operating applications, which are integrated with the control system applications, are the PCS7 from Siemens, Symphony from ABB and Delta V from Emerson.

Operating of such a field device is understood to mean especially the configuration and parameterization of the field device as well as running diagnostics for the purpose of early recognition of errors on one of the field devices or in the process.

From the prior art, for example from published patent applications such as DE 102009011552 A1 , DE 102004002330 A1 and DE 102009028051 A1 , devices and methods for the transmission of data between a field device and an operating device have become known. For example, in DE 102009011552 A1 a connecting system, which contains an access application, is provided to this end, wherein the access application can be transmitted to the operating device and carried out there in order to make possible the transfer of data between the field device and operating device. From DE 102009028051 A1, a data collector connected to a field device, which transmits data wirelessly to a data processing unit, has become known. In this, the data collector is connected to a corresponding wireless interface via a network of the Ethernet variety. Furthermore, it has become known from DE 102009028051 A1 , to emulate the operation of a field device on a remote terminal, and to display content produced in this way via a web browser.

In this, however, is the disadvantage that one specific form of hardware must be available, that is a specific form of a communication interface and in particular an Ethernet interface, as described in e.g. DE 102009028051 A1, so that the corresponding content can be, for example, displayed on a webbrowser.

It is therefore the object of the present invention to allow the operating of a field device, essentially independent of the attendant hardware of the communication interface.

The object is achieved, according to the invention, through a method, an assembly and a computer program product.

With regard to the method, the object is thereby achieved, in that data is exchanged via a connection between the field device and a operating device, for operating the field device, wherein the connection is established via a communication interface on the field device and a communication interface on the operating device, wherein the communication interface of the operating device is a hardware communication interface, which is emulated by software as an Ethernet interface.

In an embodiment of the method, the Internet Protocol (IP) is used for communication on the operating device side via the communication interface of the operating device, and the communication interface of the operating device is assigned an IP address, to which the communication interface of the operating device, in particular on the operating device side, is addressed.

In a further embodiment of the method, the field device and the operating device are connected via a connecting system, preferably a cable, wherein the connecting system is connected to the communication interface of the field device, by way of example to an available communication port on the field device, and to the communication interface of the operating device, by way of example to an available communication port on the operating device.

In a further embodiment of the method, the connecting system can be connected to a variety of field devices. For this reason, the connecting system can comprise corresponding standardized ports, which serve for the connection with the respective communication interface of the field device or operating device, as the case may be. In a further embodiment of the method, the connecting system comprises a data processing unit, which is connected to the communication interface of the field device via a first sub connection of the connecting system and to the communication interface of the operating device via a second sub connection of the connecting system.

In a further embodiment of the method, the data processing unit comprises a web server, and the data is transmitted to the operating device by means of the web server.

In a further embodiment of the method, the operating, and in particular the parameterization, of the field device is achieved via a web browser, preferably in the operating device.

In a further embodiment of the method, the communication interface of the field device is an interface for communication via the fieldbus or a operate interface of the field device.

In a further embodiment of the method, the data from the field device is transmitted via the first sub connection to the data processing unit by means of field device specific protocol.

In a further embodiment of the method, the hardware communication interface of the operating device is a USB interface.

In a further embodiment of the method, Ethernet packets or Ethernet frames are transmitted, encapsulated as USB data packets, via the second sub connection between the data processing unit, in particular the web server, and the operating device.

In a further embodiment of the method, the power for the field device and/or the data processing unit is supplied via the communication interface of the operating device.

In a further embodiment of the method, the connecting system, in particular the data processing unit, comprises a replaceable memory unit, and, preferably, field device drivers and field device descriptions as the case may be, which are used for the operating of the field device, are saved on the memory unit, preferably so that the field device drivers and field device descriptions as the case may be, which are stored on the memory unit are loaded by the data processing unit and are used for communication with the field device.

In a further embodiment of the method, a so called SD memory card slot is employed as an interface of the connecting system, in particular of the data processing unit.

In a further embodiment of the method, a further digital data processing unit such as, by way of example, a PC or a smart phone, is used as an operating device.

In terms of the assembly, the object is achieved by means of an assembly comprising a field device, as well as an operating device, and preferably a connecting system for carrying out the method in accordance with one of the named embodiments of the recommended methods.

In terms of the computer program product, the object is achieved by means of a computer program product with a program code means for carrying out the method in accordance with one of the named embodiments.

The invention is described in detail on the basis of the following drawing.

It shows:

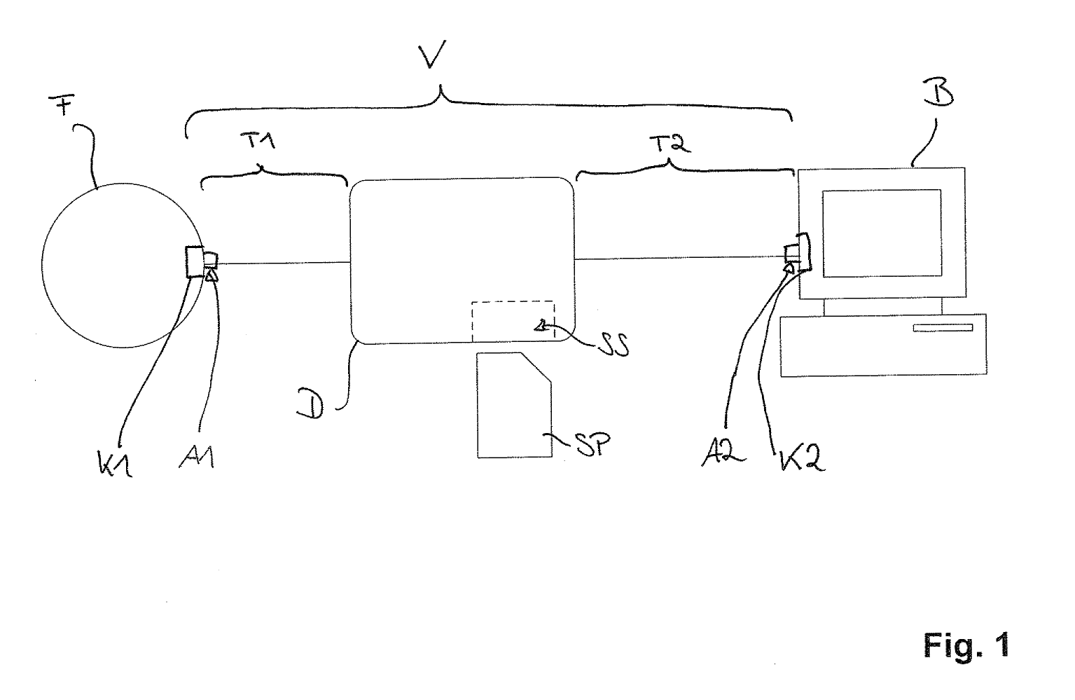

FIG. 1: A schematic representation of an embodiment according to the recommended invention comprising a field device, a connecting system and an operating device.

The field device F may be a sensor, an actuator and/or a display unit. In general, the field device F may be a device that is employed on-site in an installation of process automation technology. The connecting system V, according to the embodiment drawn in FIG. 1, is connected to the field device F via the CDI port K1 of the field device F. The so called CDI port K1 is a operate port of the field device. Alternatively, the connecting system V can also be connected to a (not shown) field bus port of the field device F.

The connecting system V is also connected to the operating device B, in this case a PC. The connecting system V can thus comprise at least a first and a second port A1, A2, which, by way of example, are present at the ends of a cable. The connecting system V is connected to the field device F as well as the operating device B via these ports. Thereby, the connection is preferably established via the respective communication interfaces K1, K2 on the field device F as well as the operating device B. Data can then be transmitted from the field device F to the operating device B as well as from the operating device B to the field device F via this connection.

The connecting system V, in accordance with FIG. 1, still additionally comprises a data processing unit D, which comprises a (not shown) microcontroller. A protocol conversion can be achieved by means of the data processing unit D between a first protocol, which is used for the communication via the communication interface port K1 of the field device F, and a second protocol, which is used for the communication via the communication interface K2 of the operating device B. Transmission of data is therefore achieved between the field device F and the data processing unit D in accordance with the first protocol via a first sub connection T1 of the connecting system V and a transmission of data between the data processing unit V and the operating device B in accordance with the second protocol via a second sub connection T2 of the connecting system V.

For the transmission of data between the data processing unit D and the operating device B, that is, via the second sub connection T2, a (not shown) web server is used, according to the embodiment in FIG. 1, which is hosted on the data processing unit D. The data can be accessed and/or displayed on the operating device B via a respective (not shown) web browser. The transmission of the data is thereby achieved via a hardware communication interface K2 of the operating device. This hardware communication interface K2 is preferably a communication interface in accordance with the USB standard. In accordance with the USB standard, data as well as electrical supply voltage can be transmitted via a suitable interface, i.e. an interface that conforms to the USB standard. In order to make possible particularly simple communication via an interface of this sort, especially of the sort where data can be accessed from a web browser, the communication interface K2 is emulated as an Ethernet interface. The communication interface K2 of the operating device B can, in this way, by way of example, be assigned an IP address, with which the communication interface K2 is addressable. Data from the web server of the data processing unit D of the connecting system V can be accessed via the web browser by means of the IP address, even though, in terms of hardware, no Ethernet interface is present. It is also an advantage that the field device F does not have to comprise an integrated web server, because the web server is integrated in the connecting system V. Parameterization of the field device F, by way of example, can be achieved via the user interface of the web browser.

Data, which is exchanged between the web server and web browser, can be present, by way of example, in the form of Ethernet packets or Ethernet frames and can be encapsulated/embedded, for the transmission via the hardware communication interface K2, in the telegrams or packets of the protocol used for the transmission of data via the communication interface K2. This corresponds to the process of tunneling of Ethernet-packets/-frames.

The data processing unit D of the connecting system V can moreover comprise a memory unit SP, e.g. a replaceable memory unit. This memory unit SP can be connected to the data processing unit D via an interface SS of the data processing unit D. As is shown in FIG. 1, the memory unit SP may be an SD memory card, and the interface SS may be a corresponding SD memory card slot. Suitable software updates, which serve, among other things, for the better operating of the field device F, can thereby be carried out by the loading of an update stored in the memory unit SP, such as, by way of example, a field device description or a field device driver, and then the executing of said update by the data processing unit D.

### LIST OF REFERENCE CHARACTERS

F Field Device

B Operating Device

V Connecting System

D Data Processing Unit

T1 First Sub Connection

T2 Second Sub Connection

A1 Field Device Side Connecting System Port

A2 Operating device Side Connecting System Port

K1 Communication Interface of the Field Device

K2 Communication Interface of the Operating device

SS Interface of the Data Processing Unit for the Memory Unit

SP Memory Unit

1-16. (canceled)

17. A method for the operating of a field device of process automation technology, comprising the steps of:
exchanging via a connection between the field device and an operating device, for operating the field device;
establishing the connection via a communication interface on the field device and a communication interface on the operating device; and
providing the communication interface of the operating device as a hardware communication interface, which is emulated by software as an Ethernet interface.

18. The method as claimed in claim 17, wherein:
the Internet Protocol, is used for communication on the operating device side via the communication interface of the operating device; and
the communication interface of the operating device is assigned an IP address, with which the communication interface of the operating device, in particular on the operating device side, is addressed.

19. The method as claimed in claim 17, wherein:
the field device and the operating device are connected via a connecting system, preferably a cable; and
the connecting system is connected to the communication interface of the field device, and to the communication interface of the operating device.

20. The method as claimed in claim 19, wherein:
the connecting system can be connected to a variety of field devices.

21. The method as claimed in claim 19 wherein:
the connecting system comprises a data processing unit, which is connected to the communication interface of the field device via a first sub connection of the connecting system and to the communication interface of the operating device via a second sub connection.

22. The method as claimed in claim 21, wherein:
the data processing unit comprises a web server; and
the data is transmitted to the operating device by means of the web server.

23. The method as claimed in claim 17, wherein:
the operating, in particular the parameterization, of the field device is achieved via a web browser, preferably in the operating device.

24. The method as claimed in claim 17, wherein:
the communication interface of the field device is an interface for communication via the fieldbus or an operating interface of the field device.

25. The method as claimed in claim 21, wherein:
the data from the field device is transmitted via the first sub connection to the data processing unit by means of field device specific protocol.

26. The method as claimed in claim 25, wherein:
the hardware communication interface of the operating device is a USB interface.

27. The method as claimed in claim 26, wherein:
Ethernet packets or Ethernet frames are transmitted, encapsulated as USB data packets, via the second sub connection between the data processing unit, in particular the web server, and the operating device.

28. The method as claimed in claim 17, wherein:
the power for the field device and/or the data processing unit is supplied via the communication interface of the operating device.

29. The method as claimed in claim 17, wherein:
the connecting system, in particular the data processing unit, comprises a replaceable memory unit, and, preferably, field device drivers or rather field device descriptions for the operating of the field device, are saved on the memory unit, which are used for the operating of the field device, preferably so that the field device drivers and field device descriptions, respectively, stored on the memory unit are loaded by the data processing unit and are used for communication with the field device, preferably via the second sub connection.

30. The method as claimed in claim 29, wherein:
a so called SD memory card slot is employed as an interface of the connecting system, in particular of the data processing unit.

31. An assembly comprising a field device, as well as an operating device, and preferably a connecting system for carrying out the method, comprising the steps of:
exchanging via a connection between the field device and an operating device, for operating the field device;
establishing the connection via a communication interface on the field device and a communication interface on the operating device; and
providing the communication interface of the operating device as a hardware communication interface, which is emulated by software as an Ethernet interface.

32. A computer program product with a program code means for carrying out the method comprising the steps of:
exchanging via a connection between the field device and an operating device, for operating the field device;
establishing the connection via a communication interface on the field device and a communication interface on the operating device; and
providing the communication interface of the operating device as a hardware communication interface, which is emulated by software as an Ethernet interface.
